(19) United States
(12) Patent Application Publication
(10) Pub. No.: US 2002/0083647 A1
(43) Pub. Date: Jul. 4, 2002

(54) Structural window lift module

(76) Inventors: Bruce R. Bostian, Bristol, IN (US); William T. Dufour, Shelby Township, MI (US); Larry J. Olivieri, Lake Orion, MI (US); Robert Michael Sutherland, West Bloomfield, MI (US)

Correspondence Address: Porter, Wright, Morris & Arthur LLP, Intellectual Property Group, 28th Floor, 41 South High Street, Columbus, OH, 43215-6194, US

(21) Appl. No.: 09/751,019

(22) Filed: Dec. 28, 2000

(51) Int. Cl. E05F 15/08

(52) U.S. Cl. 49/352; 49/349

(57) ABSTRACT

A structural window lift module is provided that comprises a door frame, a windowpane movable between a closed position and an open position, drive means for generating a force to move the windowpane, and a cable assembly operatively connecting the drive means to the windowpane. The door frame has a fore section, an aft section, and a header section. The fore section of the door frame slidably guides a fore edge of the windowpane and the aft section of the door frame slidably guides an aft edge of the windowpane. The cable assembly comprises at least one cable attachment bracket connected to the windowpane, at least one cable operatively connecting the drive means to the at least one cable attachment bracket, and at least one cable guide attached to the door frame and routing the at least one cable between the cable attachment bracket or brackets and the drive means.

### FIELD OF THE INVENTION

The present invention generally relates to an improved window lift module for a motor vehicle, and, more particularly, to an improved structural window lift module.

### BACKGROUND OF THE INVENTION

Conventional window regulators used in motor vehicle doors for raising and lowering windowpanes are often of the so-called cable-drum variety. Cable-drum window regulators typically have a cable connecting drive means such as a drive motor to a glider. The glider is connected to the windowpane via an attachment bracket and is slidable over a rail or channel. The rail is typically mounted in an inside cavity of the motor vehicle door so that it is not visible from outside the door. Operation of the motor turns a drum which pulls the cable which in turn pulls the glider over the rail to guide the windowpane assembly between a closed position where the windowpane closes an opening and an open position where the windowpane moves at least partially into the cavity in the motor vehicle door. Glass run channels on either side of the windowpane and a header provide a sealing structure for the windowpane. For proper functioning of the window regulator, the rail must be aligned with the run channels; otherwise the run channels may not properly control the windowpane and/or there could be unacceptably high efforts to move the windowpane, and even jamming if the run channels and the rail are sufficiently misaligned. It would be desirable to eliminate the rail from a cable-drum window regulator and yet still provide proper windowpane guidance, stability, and control.

Traditionally, window regulators have been assembled separate from the rest of the door, and are only attached to the windowpane and installed into the door at final assembly. However, this can involve awkward assembly processes, as the regulator often needs to be installed through a relatively small opening in an inner panel of the door. Recently, simple door cassettes have been developed wherein typically mechanisms for mounting the glass are affixed to a small plate. Other mechanisms may also be assembled together with the plate as a unit prior to installation into the motor vehicle However, since the windowpane is not attached to this cassette until original equipment manufacturer (OEM) final assembly, critical functions of these devices, including windowpane cycling, cannot be adequately tested as a stand alone unit separate from the motor vehicle It would be desirable to produce a window regulator designed for such a door module having enhanced assembly characteristics where a pre-assembled modular unit can be tested and adjusted prior to final assembly.

Accordingly, there is a need in the art for a structural window lift module with reduced cost and complexity, enhanced manufacturability, and high reliability in operation.

### SUMMARY OF THE INVENTION

The present invention provides a structural window lift module which overcomes at least some of the above-noted problems of the related art. According to the present invention, a structural window lift module is provided that comprises, in combination, a door frame, a windowpane movable between a closed position and an open position, drive means for generating a force to move the windowpane, and a cable assembly operatively connecting the drive means to the windowpane. The door frame has a fore section, an aft section, and a header section connecting the fore and aft sections. The fore section of the door frame slidably guides a fore edge of the windowpane and the aft section of the door frame slidably guides an aft edge of the windowpane. The cable assembly comprises at least one cable attachment bracket connected to the windowpane, at least one cable operatively connecting the drive means to the at least one cable attachment bracket, and at least one cable guide attached to the door frame and routing the at least one cable between the at least one cable attachment bracket and the drive means.

In one preferred embodiment of the present invention, each of the fore and aft sections of the door frame define a groove The grooves slidably receive the respective fore and aft edges of the windowpane. In an alternative preferred embodiment, each of the fore and aft sections of the door frame has an attached guide member. The guide members slidably receive the respective fore and aft edges of the windowpane.

According to yet another preferred embodiment of the present invention, the structural window lift module comprises a door frame, a windowpane movable between a closed position and an open position, drive means for generating a force to move the windowpane, and a cross-cable assembly operatively connecting the drive means to the windowpane. The door frame has a fore section, an aft section, a header section connecting the fore and aft sections, and a cross member connected to the fore and aft sections. The fore section of the door frame slidably guides a fore edge of the windowpane and the aft section of the door frame slidably guides an aft edge of the windowpane. The cross-cable assembly comprises a first cable attachment bracket connected to the windowpane adjacent the fore edge of the windowpane, a second cable attachment bracket connected to the windowpane adjacent the aft edge of the windowpane, at least one cable operatively connecting the drive means to the first and second cable attachment brackets, and four cable guides. Two cable guides are mounted on the cross member. A third cable guide is mounted on a lower portion of the aft section of the door frame, and a fourth cable guide is mounted on a lower portion of the fore section of the door frame. The at least one cable is routed in an X-shape between the four cable guides.

From the foregoing disclosure and the following more detailed description of various preferred embodiments it will be apparent to those skilled in the art that the present invention provides a significant advance in the technology and art of window lift modules. Particularly significant in this regard is the potential the invention affords for providing a structural window lift module with reduced cost and complexity, enhanced manufacturability, and high reliability in operation. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is an outboard side view of a structural window lift module according to one preferred embodiment of the present invention shown with the windowpane in a closed position;

FIG. 2 is an outboard side view of the structural window lift module of FIG. 1 shown with the windowpane in an open position;

FIG. 3 is a enlarged view of a portion of the structural window lift module shown in FIG. 1;

FIG. 4 is a side view of the portion of the structural window lift module encircled in FIG. 3 shown in a partially assembled state without the windowpane and without the glass attachment bracket;

FIG. 5 is a cross sectional view of the portion of the structural window lift module shown in FIG. 3 taken along line B-B;

FIG. 6 is a cross sectional view of a portion of the structural window lift module shown in FIG. 1 taken along line A-A of FIG. 1;

FIG. 7 is a cross sectional view of a portion of an alternative embodiment of the present invention shown at a position equivalent to that shown in FIG. 6.

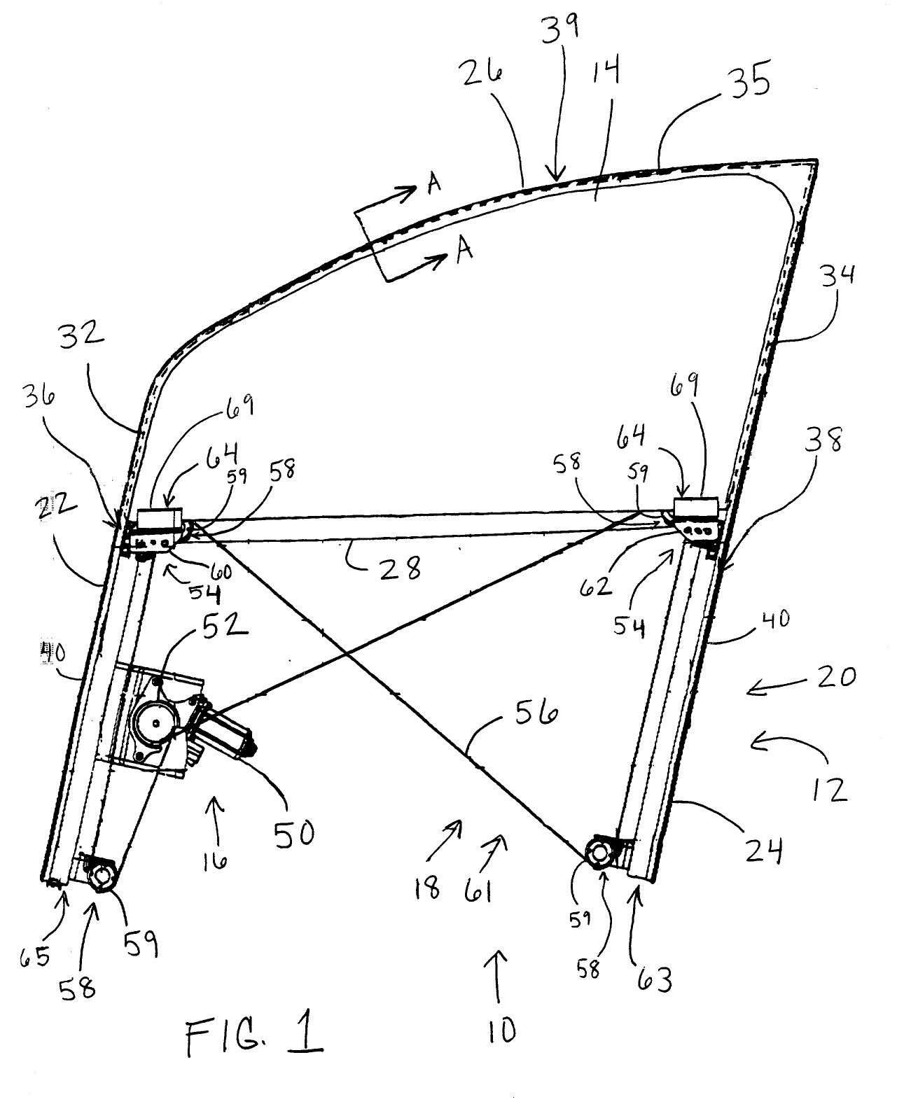

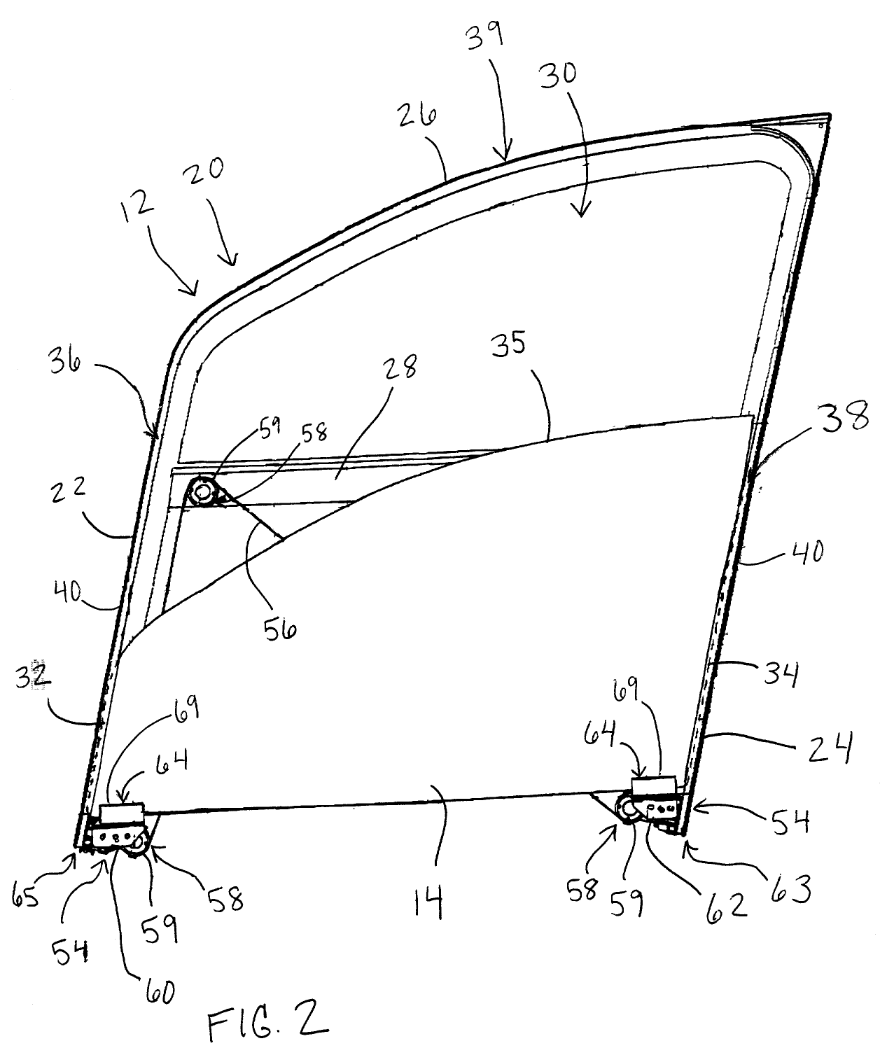

It should be understood that the appended drawings are not necessarily to scale, presenting a somewhat simplified representation of various preferred features illustrative of the basic principles of the invention. The specific design features of the structural window lift module as disclosed herein, including, for example, specific dimensions, orientations, and shapes of the structural portion and run channels will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the structural window lift module illustrated in the drawings. In general, inboard-outboard refers to a plane normal to the plane of the paper in FIGS. 1 and 2, up or upward refers to an upward direction in the plane of the paper in FIGS. 1 and 2, and down or downward refers to a downward direction in the plane of the paper in FIGS. 1 and 2. In general, fore or forward refers to a direction toward the front of the lift module, that is, in a leftward direction in the plane of the paper in FIGS. 1 and 2. Also in general, aft or rearward refers to a direction toward the rear of the lift module, that is, in a rightward direction in the plane of the paper in FIGS. 1 and 2.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved structural window lift module disclosed herein. The following detailed discussion of various alternative and preferred embodiments will illustrate the general principles of the invention with reference to a structural window lift module for a motor vehicle door. Other embodiments suitable for other applications will be readily apparent to those skilled in the art given the benefit of this disclosure.

Referring now to the drawings, FIGS. 1-7 illustrate preferred embodiments of a structural window lift module 10 according to the present invention. While the illustrated embodiments of the structural window lift module 10 of the present invention are particularly adapted for use in a motor vehicle door, it is noted that principles of the invention are applicable to modules for use with other applications having a movable windowpane.

FIGS. 1-6 illustrate a preferred embodiment of the invention. FIGS. 1-2 illustrate outboard side views of a preferred embodiment of a structural window lift module 10 according to the present invention. The structural window lift module 10 comprises a structural portion 12, a windowpane 14, drive means 16 for generating a force to move the windowpane 14, and a cable assembly 18 operatively connecting the drive means 16 to the windowpane 14 for transmitting the force to move the windowpane 14.

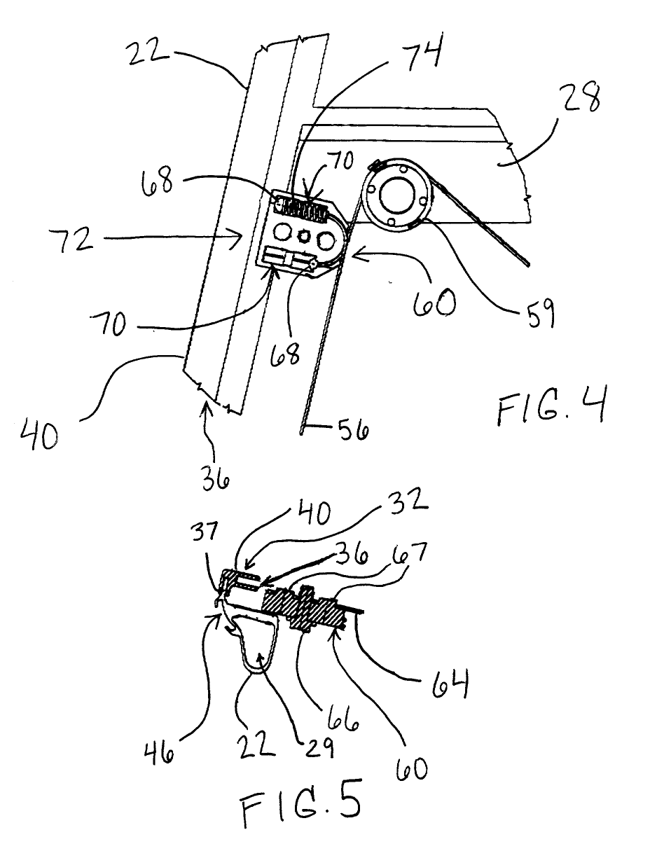

In the preferred embodiment, the structural portion 12 comprises a door frame 20. The door frame 20 preferably comprises a fore section 22, an aft section 24, and a header section 26 connecting the fore 22 and aft 24 sections. The fore 22, aft 24, and header 26 sections may be one continuous piece or may be separate segments joined together. The door frame 20 may also comprise a cross member 28 connecting midsections of the fore 22 and aft 24 sections. The cross member 28 and the fore 22, aft 24, and header 26 sections cooperate to form an opening 30 (FIG. 2). The door frame 20 may be a roll-formed metal extrusion defining a hollow portion 29 (FIG. 5). Those skilled in the art given the benefit of the present disclosure will recognize that the door frame 20 may be manufactured using other suitable processes.

Although not shown in the drawings, the structural window lift module 10 may also comprise an inner panel attached on the inboard side of the lift module 10 and an outer panel attached on the outboard side of the lift module 10. The inner and outer panels preferably enclose the lift module 10 from the bottom of the fore 22 and aft 24 sections of the door frame 20 to a position around the top of the cross member 28 of the door frame 20. The inner and outer panels form a beltline or midsection that cooperates with the fore 22, aft 24, and header 26 sections of the door frame 20 to define an opening that may have the same area or a different area than the opening 30. A windowpane receiving entrance is formed between the inner and outer panels that receives the windowpane 14 into a cavity or well formed by the inner and outer panels Preferably, the windowpane 14 is attached as part of the lift module 10 prior to final installation into a motor vehicle, allowing for cycle testing as a pre-assembled unit. The lift module 10 may have hinges to attach to the motor vehicle body, a locking mechanism, rearview mirrors, armrest instrument controls, or other functional attachments included. Other functional attachments will be apparent to those skilled in the art given the benefit of this disclosure.

The windowpane 14 is movable between an open position (illustrated in FIG. 2) and a closed position (illustrated in FIG. 1) where the windowpane 14 closes the opening 30. The windowpane 14 has a fore edge 32 (shown in phantom in FIGS. 1, 2, and 3) and an aft edge 34 (shown in phantom in FIGS. 1 and 2). The fore edge 32 of the windowpane 14 is slidably disposed within a fore run channel 36 of the fore section 22 of the door frame 20 and the aft edge 34 is slidably disposed within an aft run channel 38 of the aft section 24 of the door frame 20 so that the fore section 22 of the door frame 20 slidably guides the fore edge 32 of the windowpane 14 and the aft section 24 of the door frame 20 slidably guides the aft edge 34 of the windowpane 14. The header section 24 may also have a header run channel 39 to accept a top edge 35 (shown in FIG. 2 and shown in phantom in FIG. 1) of the windowpane 14.

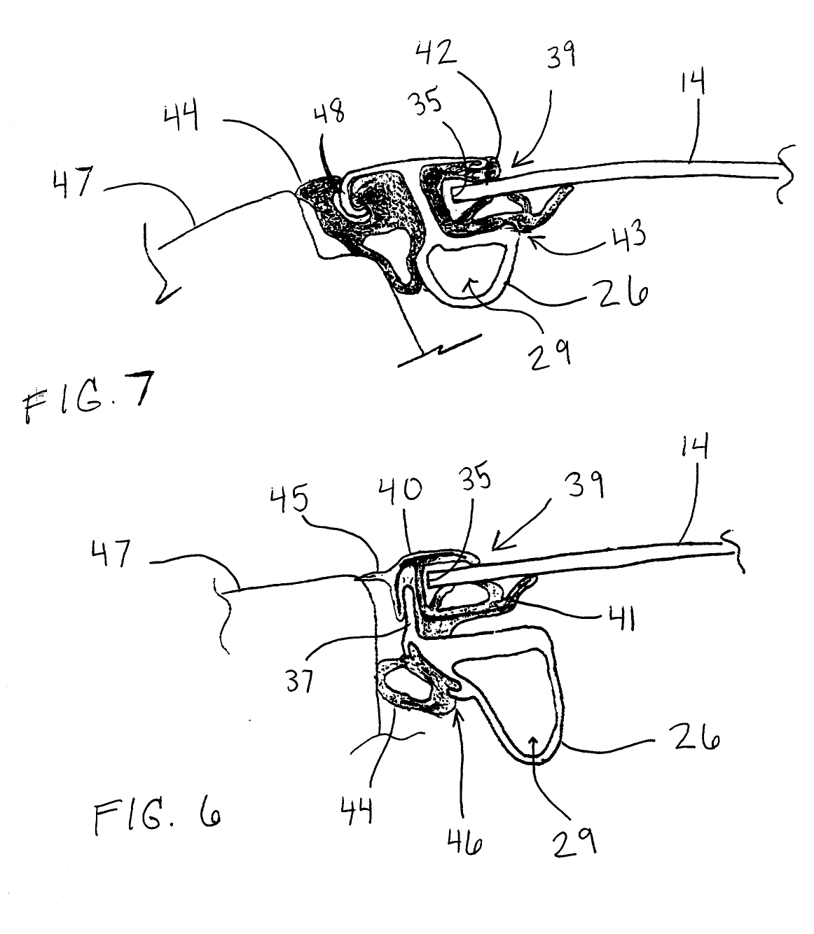

FIGS. 5-7 illustrate alternative embodiments of door frames 20 having different cross-sectional shapes. In one preferred embodiment illustrated in FIGS. 5 and 6, the run channels 36, 38, 39 comprise a guide member 40 that is attached to the fore 22, aft 24, and header 26 sections of the door frame 20 on a flange 37 of the door frame 20. The guide member 40 slidably receives the respective fore 32 and aft 34 edges of the windowpane 14. The guide member 40 may be one continuous piece running from the bottom of the fore section 22 of the door frame 20 along the fore section 22 and the header section 26 and back down the aft section 24 of the door frame 20, or the guide member 40 may be separate segments. A segmented guide member 40 may be used, for example, to aid the fore 32 and aft 34 edges of the windowpane 14 in sliding and to seal the windowpane 14 from exterior elements. As illustrated in FIG. 5, the guide member 40 acts only as a guide below the cross member 28 or beltline and is formed from a hard, slick material that reduces friction between the windowpane 14 and the guide member 40. As illustrated in FIG. 6, the guide member 40 acts as a seal above the cross member 28 or beltline and is a formed from a sealing material with an inner metal frame 41 for structural integrity. The embodiment illustrated in FIGS. 5 and 6 allows the windowpane 14 to be positioned flush with an exterior surface of a motor vehicle, a feature that is highly advantageous to exterior styling of a motor vehicle.

In another preferred embodiment of the door frame 20 and as illustrated in FIG. 7, the fore 22, aft 24, and header 26 sections of the door frame 20 each have a respective run channel 36, 38, 39 that is formed by respective fore, aft, and header grooves 43 in the door frame 20. The respective fore 36 and aft 38 run channels slidably receive the fore 32 and aft 34 edges of the windowpane 14. The channels 43 may have a guide member 42 positioned in the channels 43 to aid the fore 32 and aft 34 edges of the windowpane 14 in sliding and/or to seal the windowpane 14 from exterior elements, as described above in connection with the embodiment illustrated in FIGS. 5 and 6. Also as described above, the guide member 42 may be one continuous piece, or the guide member 42 may be separate segments. Those skilled in the art given the benefit of this disclosure will recognize that door frames 20 with other shapes and run channels with different shapes and positions can be used in the present invention.

As best illustrated in FIGS. 6 and 7, the structural window lift module 10 may also comprise a seal or seals 44 for forming a seal between the door frame 20 and a motor vehicle body 47. FIG. 6 shows a seal 44 attached to the door frame 20 in a groove 46 of the door frame 20. The guide member 40 is also shown with a seal portion 45 for forming a seal between the windowpane 14, door frame 20, and the motor vehicle body 47. FIG. 7 shows a seal 44 attached to the door frame 20 around a flange 48 of the door frame 20. Those skilled in the art given the benefit of this disclosure will recognize that other seals 44 and seal assemblies for forming a seal between the door frame 20 and a motor vehicle body can be used in the present invention.

As best illustrated in FIGS. 1 and 2, the motion of the windowpane 14 is controlled by drive means 16 such as, for example, a motor 50 (FIG. 1) or a hand crank (not shown) FIG. 1 shows the motor 50 attached to the fore section 22 of the door frame 20, but the motor 50 may be attached to the door frame 20 at any location. The motor 50 is operatively connected to a cable drum 52 that is operatively attached to the cable assembly 18. The drive means 16 pulls on the cable assembly 18 to move the windowpane 14, as described in more detail below.

The cable assembly 18 preferably comprises at least one cable attachment bracket 54 connected to the windowpane 14, at least one cable 56 operatively connecting the drive means 16 to the cable attachment bracket or brackets 54, and at least one cable guide 58 (such as, for example, a pulley 59 or slider) attached to the structural portion 12. The cable guide or guides 58 route the cable or cables 56 between the cable attachment bracket or brackets 54 and the drive means 16 so that the force of the drive means 16 is translated to the cable attachment bracket or brackets 54 to slide the windowpane 14 in the run channels 36,38.

In the preferred embodiment and as best illustrated in FIG. 1, the cable assembly 18 comprises a cross-cable assembly 61. The cross-cable assembly 61 comprises a first cable attachment bracket 60 connected to the windowpane 14 adjacent the fore edge 32 of the windowpane 14, a second cable attachment bracket 62 connected to the windowpane 14 adjacent the aft edge 34 of the windowpane 14, two cable guides 58 mounted on the cross member 28, a cable guide 58 mounted on a lower portion 63 of the aft section 24 of the door frame 20, and a cable guide 58 mounted on a lower portion 65 of the fore section 22 of the door frame 20. At least one cable 56 operatively connects the motor 50 to the first 60 and second 62 cable attachment brackets. The cable or cables 56 are preferably routed in an X-shape between the four cable guides 58, although other cable configurations will be apparent to those skilled in the art given the benefit of this disclosure. In the preferred embodiment, the cable or cables 56 advantageously do not slide through any conduits or drag across any surfaces, thereby reducing the friction associated with conventional designs and increasing the efficiency of the window regulator.

In a highly advantageous feature, the door frame 20 acts as a structural member, a guide for the windowpane 14, and as a mounting member for the cable guides 58, thereby simplifying assembly by eliminating the need for a guide rail or rails for guiding a gliding element. Structural here means that the door frame 20 preferably is integrated with any other structural elements of the door to contribute substantial overall rigidity for preventing excessive deflection of the door in the course of normal vehicle operation (e.g., deflection to such an extent that audible wind noise occurs between the door frame 20 and the windowpane 14 or that permanent bending occurs). This is important since excessive deflection can result in improper sealing, squeaks, rattles and buzzes, and potential water entry.

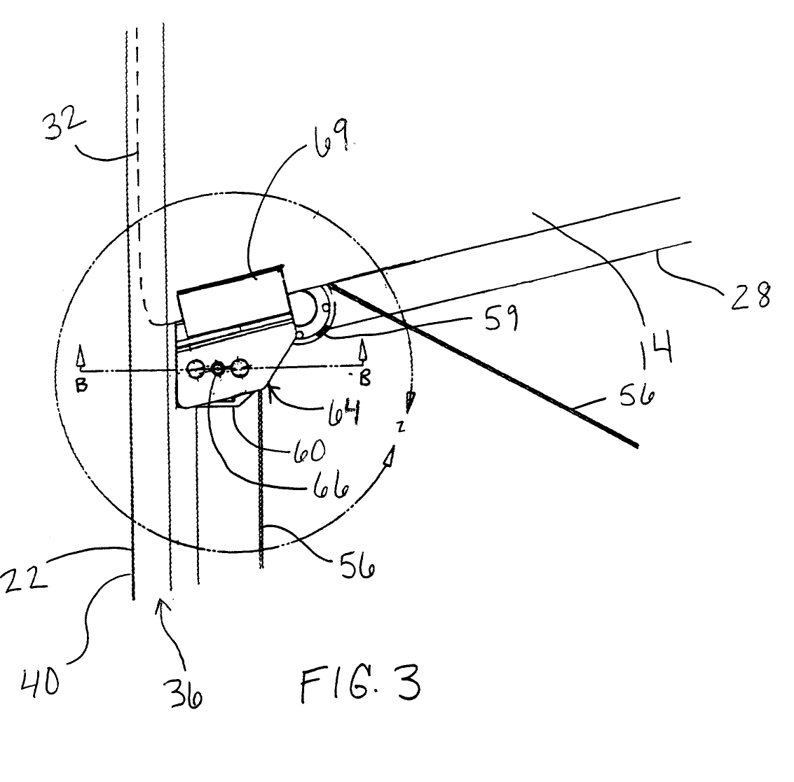

The first cable attachment bracket 60 is positioned adjacent a lower corner of the fore edge 32 of the windowpane 14 and the second cable attachment bracket 62 is positioned adjacent a lower comer of the aft edge 34 of the windowpane 14. As shown in FIGS. 3 and 5, each cable attachment bracket 54 may include a glass attachment bracket 64. Each cable attachment bracket 54 is attached to one glass attachment bracket 64 using protrusions 67 and a screw 66 or other connector. The glass attachment bracket 64 preferably includes a flange 69 on each side of the windowpane 14, but those skilled in the art will recognize that the glass attachment bracket 64 may be positioned on only one side of the windowpane 14 in certain embodiments of the present invention. The two flanges 69 of the glass attachment bracket 64 are glued to the windowpane 14 or attached to the windowpane 14 by other conventional means.

As illustrated in FIG. 4, each cable 56 in the cable assembly 18 preferably has an end cap or ball 68 that is placed in a channel 70 of the cable attachment bracket 54. For clarity, FIG. 4 is shown in a partially assembled state without the windowpane 14 and without the glass attachment bracket 64. The cable attachment brackets 60, 62 both preferably comprise a cable tensioning device 72 adapted to maintain tension on the cable or cables 56 while allowing for a variable length of the cable or cables 56. A spring 74 is placed around a cable 56 with the end cap 68 of the cable 56 fitting against the spring 74. Because the spring 74 has a smaller diameter than the end cap 68, the end cap 68 compresses the spring 74 when tension increases on the cable 56, and when the tension decreases, the spring 74 decompresses to take up any slack in the cable 56.

From the foregoing disclosure and detailed description of certain preferred embodiments, it will be apparent that various modifications, additions and other alternative embodiments are possible without departing from the true scope and spirit of the present invention. For example, it will be apparent to those skilled in the art, given the benefit of the present disclosure, the run channels and the door frame of the structural window lift module 10 can have may different shapes. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A structural window lift module comprising, in combination:
a door frame, the door frame having a fore section, an aft section, and a header section connecting the fore and aft sections;
a windowpane movable between a closed position and an open position, the windowpane having a fore edge and an aft edge, wherein the fore section of the door frame slidably guides the fore edge of the windowpane and the aft section of the door frame slidably guides the aft edge of the windowpane;
drive means for generating a force to move the windowpane; and
a cable assembly operatively connecting the drive means to the windowpane comprising:
at least one cable attachment bracket connected to the windowpane;
at least one cable operatively connecting the drive means to the at least one cable attachment bracket; and
at least one cable guide attached to the door frame and routing the at least one cable between the at least one cable attachment bracket and the drive means.

2. The structural window lift module of claim 1 wherein the door frame further comprises a cross member and wherein the fore, aft, and header sections cooperate with the cross member to form an opening closed by the windowpane when the windowpane is in the closed position.

3. The structural window lift module of claim 1 wherein each of the fore and aft sections of the door frame define a groove, the grooves slidably receiving the respective fore and aft edges of the windowpane.

4. The structural window lift module of claim 1 wherein each of the fore and aft sections of the door frame has an attached guide member, the guide members slidably receiving the respective fore and aft edges of the windowpane.

5. The structural window lift module of claim 4 wherein the windowpane is generally flush with an exterior surface of a motor vehicle.

6. The structural window lift module of claim 1 further comprising a seal for forming a seal between the door frame and a motor vehicle body.

7. The structural window lift module of claim 1 wherein at least one of the cable attachment brackets comprises a cable tensioning device.

8. The structural window lift module of claim 1 wherein the door frame is a metal extrusion.

9. The structural window lift module of claim 8 wherein the door frame defines a hollow portion.

10. A structural window lift module comprising, in combination:
a door frame, the door frame having a fore section, an aft section, a header section connecting the fore and aft sections, and a cross member connected to the fore and aft sections;
a windowpane movable between a closed position and an open position, the windowpane having a fore edge and an aft edge, wherein the fore section of the door frame slidably guides the fore edge of the windowpane and the aft section of the door frame slidably guides the aft edge of the windowpane;
drive means for generating a force to move the windowpane; and
a cross-cable assembly operatively connecting the drive means to the windowpane comprising:
a first cable attachment bracket connected to the windowpane adjacent the fore edge of the windowpane;
a second cable attachment bracket connected to the windowpane adjacent the aft edge of the windowpane;
at least one cable operatively connecting the drive means to the first and second cable attachment brackets;
two cable guides mounted on the cross member;
a cable guide mounted on a lower portion of the aft section of the door frame; and
a cable guide mounted on a lower portion of the fore section of the door frame;
wherein the at least one cable is routed in an X-shape between the four cable guides.

11. The structural window lift module of claim 10 wherein the fore, aft, and header sections cooperate with the cross member to form an opening closed by the windowpane when the windowpane is in the closed position.

12. The structural window lift module of claim 10 wherein each of the fore and aft sections of the door frame define a groove, the grooves slidably receiving the respective fore and aft edges of the windowpane.

13. The structural window lift module of claim 10 wherein each of the fore and aft sections of the door frame has an attached guide member, the guide members slidably receiving the respective fore and aft edges of the windowpane.

14. The structural window lift module of claim 13 wherein the windowpane is generally flush with an exterior surface of a motor vehicle.

15. The structural window lift module of claim 10 further comprising a seal for forming a seal between the door frame and a motor vehicle body.

16. The structural window lift module of claim 10 wherein at least one of the cable attachment brackets comprises a cable tensioning device.

17. The structural window lift module of claim 10 wherein the door frame is a metal extrusion.

18. The structural window lift module of claim 17 wherein the door frame defines a hollow portion.
